(19) United States
(12) Patent Application Publication
(10) Pub. No.: US 2011/0008132 A1
(43) Pub. Date: Jan. 13, 2011

(54) Cover Conveyor For Perfect Binding Machine

(75) Inventors: Scott Aten, Owatonna, MN (US); Troy Hering, Elysian, MN (US)

Correspondence Address: NIKOLAI & MERSEREAU, P.A., 900 SECOND AVENUE SOUTH, SUITE 820, MINNEAPOLIS, MN, 55402, US

(73) Assignee: Brown Printing Company, a division of Gruner + Jahr Printing and Publishing, Waseco, MN (US)

(21) Appl. No.: 12/499,996

(22) Filed: Jul. 9, 2009

(51) Int. Cl. B42C 11/02; B42C 11/04

(52) U.S. Cl. 412/4; 412/19

(57) ABSTRACT

A method and apparatus for sequentially delivering book or magazine covers of the same or differing width dimension to a perfect binding system such that books or magazines of differing size can be produced without requiring system downtime for resetting of cover guiderail settings. Associated with each cover size is a cover feeder arranged to deliver covers therefrom, one a time, between members of a given pair of guiderails that are assembled in stacked parallel relationship on the bed of the cover conveyor. Under control of a microprocessor-based controller, covers of a predetermined size arrive at the gluing station of the perfect binder in synchronism with signatures of a selected size corresponding to the cover to be applied.

### BACKGROUND OF THE INVENTION

I. Field of the Invention

This invention relates generally to systems for producing perfect bound books or magazines, and more particularly to an improved cover conveyor capable of accommodating variations in cover width whereby such booklets and magazines of differing width dimension can be simultaneously accommodated without the need for system shut-down for set-up purposes.

II. Discussion of the Prior Art

So-called perfect binding systems are known in the art. Generally speaking, such systems include a plurality of sheet feeders positioned adjacent to a collating conveyor where the sheet feeders deliver signatures, one at a time, onto a moving conveyor belt that carries the collated signatures to a binding station. When all signatures for a book have been assembled, the text is clamped just above the spine and the collated text passes over a saw which cuts off about ⅛^{th} inch from the spine of each signature. At the same time, a further sheet feeder, sometimes referred in the industry as a “pocket”, delivers book covers serially onto a conveyor bed between lugs on a moving endless chain, where the lugs project up through longitudinally extending slots in the bed. Hot melt glue is applied to the cut spine of the signatures at a binding station, and the bound signatures are timed to arrive at the binding station in synchronism with a book/magazine cover where the cover is bonded to the bounded signatures in forming a book or magazine. Additional trimming steps may also be applied to the bound signatures and/or cover.

Under applicable postal rules, a lower postal rate is charged for mail presorted to an improved postal presort level. Improved presort levels are achieved by improving mailing density, which is affected by total pieces in a mailing. Thus, it behooves magazine producers to group several different magazines headed to a given postal area together for shipment. A need, therefore, exists for a perfect binding system capable of producing perfectly bound books and magazines of different size and content in an order such that the different publications destined for a particular postal area will be assembled, bound and covered as an interleaved group without having to shut down the line to perform set-up operations for the individual members of the group of publications or without having to perform a secondary process to achieve this same result. This process also allows for paper savings as all covers would not have to be created at the group's maximum width. The present invention fulfills this need.

### SUMMARY OF THE INVENTION

In accordance with the present invention, there is provided a perfect binding system for assembling plural signatures into bound books and for applying covers to said books where the perfect binding system is of the type including a conveyor bed comprising an elongated, planar, horizontal surface of a predetermined width dimension with at least one longitudinal slot formed through the horizontal surface through which a traveling lug may project vertically a predetermined distance above the surface and where a first pair of parallel guiderails is adjustably positioned along opposed side edges of the planar surface. A first cover feeder or pocket is positioned relative to the conveyor bed for delivering book covers of a first predetermined width dimension, one at a time, onto the horizontal surface in a way such that the book covers of this first predetermined width dimension guided by the pair of parallel guiderails are being carried along the conveyor bed to a gluing station and where a signature conveyor is provided for collating plural signatures onto books and moving the books to the gluing station. In accordance with the present invention, the improvement to the afore-described binding system involves a second pair of parallel guiderails that is adjustably disposed atop the first pair of parallel guiderails. A second conveyor feeder or pocket is positioned relative to the conveyor bed for feeding book covers of a second predetermined width dimension, one at a time, onto the horizontal surface of the conveyor bed such that the book covers of the second predetermined width dimension are guided by the second pair of parallel guiderails as the traveling lugs on the endless chain engage the book covers of the second predetermined width dimension to move those book covers to the gluing station. The first and second cover feeders arc arranged to deliver the book covers of the first and second width dimension onto the conveyor bed surface in vertically, non-overlapping orientation relative to one another whereby signatures of differing width dimension can be matched with a single, appropriately-sized book cover at the gluing station.

### DESCRIPTION OF THE DRAWINGS

The foregoing features, objects and advantages of the invention will become apparent to those skilled in the art from the following detailed description of the preferred embodiment especially when considered in conjunction with the accompanying drawings in which like numerals of the several views refer to corresponding parts.

FIG. 1 is a top plan view of a typical prior art perfect binding line over which the present invention constitutes an improvement;

FIG. 2 is a top plan view of a cover conveyor constructed in accordance with the present invention and usable in the perfect binding line of FIG. 1;

FIG. 3 is a side elevation of the cover conveyor of FIG. 2;

FIG. 4 is a partial perspective view of the cover conveyor of FIG. 2; and

FIG. 5 is an end view of the cover conveyor of FIG. 2 showing the stacked configuration of plural cover guide rails.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “,join” and “joining” are used interchangeably and refer to one structure or surface being secured to another structure or surface or integrally fabricated in one piece, unless expressively described otherwise

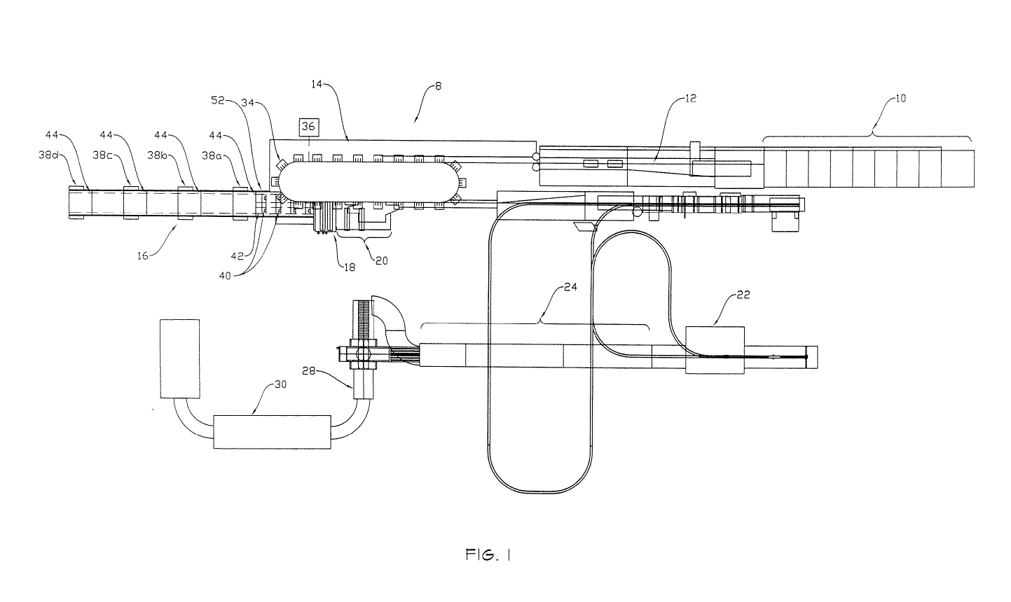

FIG. 1 is a drawing that depicts a typical, prior art perfect binding system in which the present invention finds use. The perfect binding system 8 is employed to produce magazines, catalogs, brochures, periodicals containing different collections of signatures for different subscribers. Pocket feeders 10 feed folded signatures onto a collating conveyor or gatherer 12 and when all pages comprising a magazine have been assembled on the collating conveyor, they are transferred to clamps 34 on the perfect binder 14 which travel in a counterclockwise direction in an oval path. The signatures 32 are clamped along one longitudinal edge so that their respective folds, or backbones, are directed downwardly. In this orientation, each group of signatures comprising a book or magazine is initially trimmed along its held longitudinal edge and is roughened before being presented to a gluing station 18 and then moved to a cover applicator 20. From there, a further conveyor carries the covered book or magazine to a trimmer 22 where edges are further trimmed as desired.

Also seen in FIG. 1 is a cover conveyor 16 having a plurality of cover feeders 38a, 38b, 38c and 38d for depositing one or more different covers 42 onto a conveyor bed with the side edges of the covers being constrained by cover guides 44 as lugs 40a on a driven chain that define “pockets” transport the covers to the station 20 where the covers become adhesively bonded to a book to which an adhesive has been applied at the gluing station 18.

Covered books/magazines leaving the trimmer 22 may then be conveyed to a labeling station 24 and subsequently to wrapping stations 28/30.

The movement of the perfect binder 14, the cover conveyor 16, the operation of the gluing station 20 as well as the trimmer 22 and the other components 24, 26, 28 and 30 remain appropriately synchronized by a microprocessor-based controller 36.

U.S. Pat. No. 5,316,425 particularly claims an arrangement for delivering first and second covers in superimposed relation to one another, allowing multiple covers to be affixed to a given book or magazine. As is explained in the '425 patent, this allows, for example, an outer protective craft paper cover and an inner decorative cover to be applied to a given magazine.

The present invention teaches a way of interspersing book/magazine covers of differing sizes for attachment to books/magazines of different content and size without the need for shutting down production for adjustment to the guiderails of the cover conveyor to accommodate a change in cover size. Thus, books and magazines of varying titles, content, etc. and of varying sizes but destined for the same postal zone can be produced on a continuous basis, thereby improving system throughput while reducing postal expenses.

Referred first to FIG. 2, there is indicated generally by numeral 100 a top plan view of a cover conveyor constructed in accordance with the present invention. The cover conveyor 100 comprises a conveyor bed 102 having parallel slots 104 formed there through and beneath the bed 102 are endless chains (not shown). Affixed to the chains disposed beneath the bed 102 are pusher lugs as at 106 that project up through the slots 104 and which are adapted to engage the trailing edge of a single cover to move it along the cover conveyor to the gluing station 20 of the perfect binder 8.

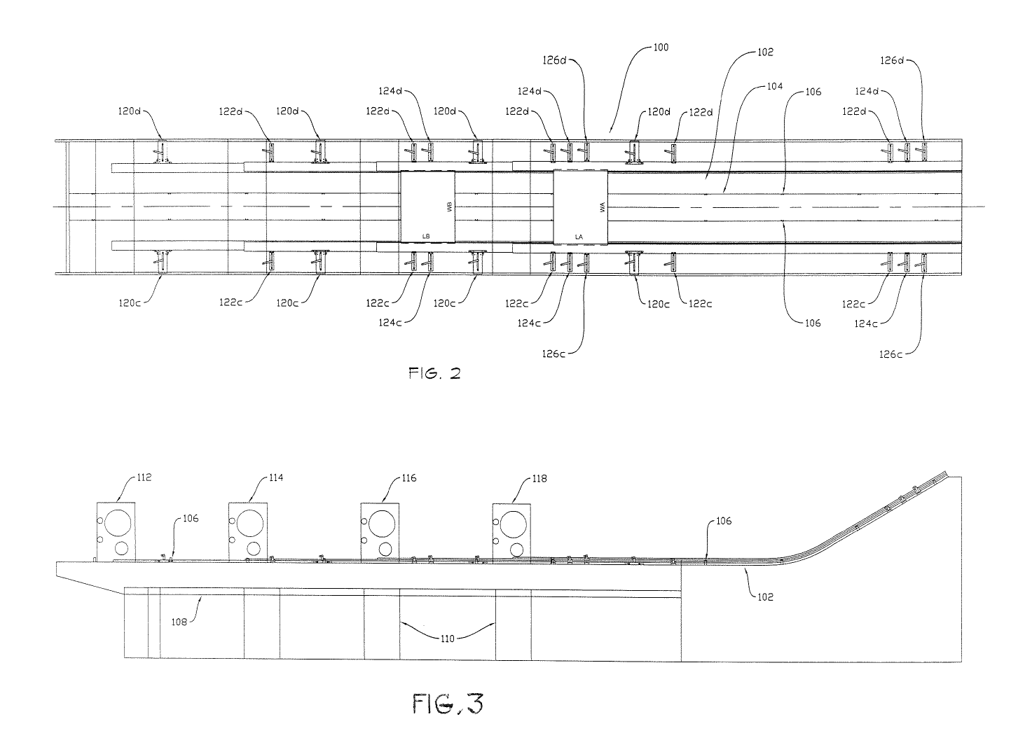

As seen in the side elevation view of FIG. 3, the cover conveyor bed 102 is mounted on a frame 108 suitably elevated from the floor by legs 110. Mounted atop the conveyor bed 102 are a plurality of cover feeders 112, 114, 116 and 118. The cover feeders are of known design and comprise a means for delivering covers, one at a time, into a spacing of the cover conveyor at timed intervals defined by adjacent traveling lugs 106. Delivery of a cover from the cover feeders 112, 114, 116 and 118 is under the control of the microprocessor-based controller 36.

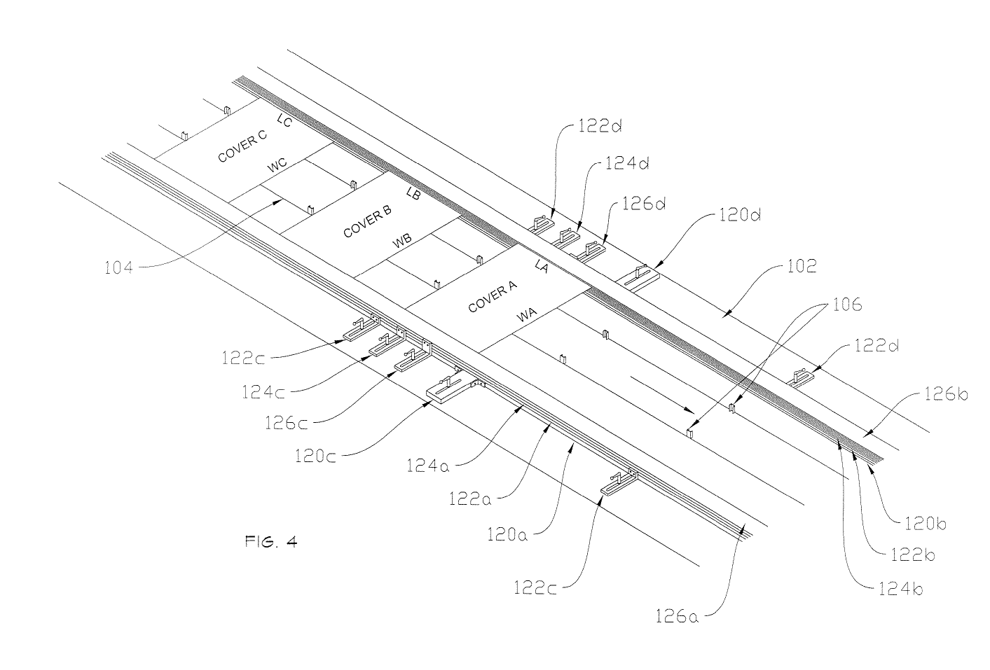

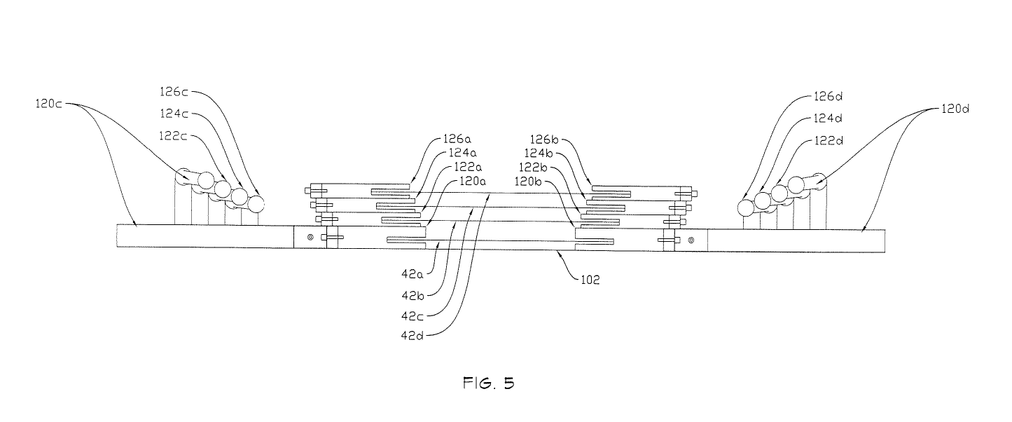

Referring next to FIGS. 4 and 5, adjustably mounted at predetermined spacings along the opposed side edges of the conveyor bed 102 is a plurality of pairs of cover guiderails including pairs 120a, 120b, 122a, 122b, 124a, 124b and 126a, 126b. A lateral spacing between cover guide members 120a and 120b are set and maintained by guide rail clamps 120c and 120d. Similarly, the spacing between guiderails 122a and 122b are set and maintained by guiderail clamps 122c and 122d. The cover guiderail pairs 124a, 124b and 126a, 126b are likewise provided with clamps 124c, 124d and 126c, 126d as best seen in FIG. 4. The lateral spacing between members of the plural guiderail pairs are made by loosening the threaded bolts that are shown passing through the slots in the clamping members and then nudging the guiderails until appropriate spacing for a given cover size is achieved. The clamping bolts are then retightened to maintain the clamp members in their set position relative to the conveyor bed 102.

Referring next to FIG. 5, the lateral spacing between the stack of guiderails 120, 122, 124 and 126a and b may be set to accommodate covers of differing width dimension and possibly differing length dimension as represented by “Cover A” and “Cover B” shown in FIG. 4 where Cover A has its edges contained within the longitudinal slots of guiderails 122a and 122b while cover B rides within the longitudinal slots in guiderails 120a and 120b.

From what has been described, those skilled in the art will appreciate that the plural cover feeders 112, 114, 116 and 118 are arranged to deliver covers 42a-42d into the longitudinal slots in the guiderail pairs 120, 122, 124 and 126a and b, respectively, and that, hence, covers of differing width (WA, WB, WC) and length (LA, LB, LC) dimension can be delivered, via the conveyor assembly 100, to match up with appropriately sized books/magazines at the glue station 20, all under control of the microprocessor-based controller 36 and that the series of covers are delivered in non-overlapping fashion such that only one such cover is appended to a given book/magazine. More particularly, and as seen in FIG. 3, cover feeder 112 is positioned to insert covers into the longitudinal slots in cover guide pair 120a,b, cover feeder 114 into the longitudinal slots in cover guide pair 122 a, b, cover feeder 116 into the longitudinal slots of cover guide pair 124a, b and cover feeder 118 into the longitudinal slots of cover guide pair 126a, b.

With the arrangement illustrated involving four stacked rail pairs, the cover conveyor 100 is able to deliver four different cover sizes, one at a time, in an order determined by the microprocessor-based controller 36.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself. For example, it should be understood that the interleaving of different magazine covers of differing widths are not applicable solely to mail, but could also be used for manufacturing bulk shipped products, by carriers other than the U.S. Postal Service to newsstands, etc. Likewise, it should be appreciated that these covers can be supplemented by customization, such as inkjet, stickering, labeling, etc. Further, other equipment not specifically outlined can be added to monitor the process to ensure quality, such as photo eyes, cameras, proximity sensors, etc.

What is claimed is:

1. In a perfect binding system for assembling plural signatures into bound: books and for applying covers to said books of the type including a cover conveyor bed comprising an elongated planar horizontal surface of a predetermined width dimension with at least one longitudinal slot formed through said surface through which a travelling lug may project vertically a predetermined distance above said surface and where a first pair of parallel guiderails are adjustably positioned along opposed side edges of the planar surface; a first cover feeder positioned relative to the cover conveyor bed for delivering book covers of a first predetermined width dimensions one at a time, onto the said surfaces, the book covers of the first predetermined width dimension being guided by the first pair of parallel guiderails as the travelling lugs engage a trailing edge of the book covers of the first predetermined width dimension to move said book covers to a gluing station and a signature conveyor for collating plural signatures into books and moving the books to said gluing station, the improvement comprising:
(a) at least one further pair of parallel guiderails stacked atop the first pair of parallel guiderails and arranged such that the spacing between members of the further pairs of parallel guiderails is adjustable;
(b) an additional cover feeder for each pair of guiderails in the stack other than the first pair, said cover feeders being positioned relative to the conveyor bed for feeding book covers of differing predetermined width dimensions one at a time, onto the said surface, the book covers of the differing predetermined width dimensions being guided by an associated pair of parallel guiderails in the stack as the traveling lugs engage the book covers of the differing predetermined width dimensions to move the book covers of the differing predetermined width dimensions to said gluing station; and
(c) the first and further cover feeders delivering the book covers onto said surface in non-overlapping vertical orientation relative to one another whereby signatures of differing width dimensions can be matched with appropriately sized book covers at said gluing station.

2. The perfect binding system as in claim 1 and further including:
(a) another pair of parallel guiderails adjustably stacked atop the further pair of parallel guiderails; and
(b) another cover feeder positioned relative to the conveyor bed for feeding book covers of a third predetermined width dimension, one at a time, onto the said surface, opposed side edges of the book covers of the third predetermined width dimension engaging the another pair of parallel guiderails.

3. The perfect binding system as in claim 1 wherein the first and at least one further pair of parallel guiderails each include an elongated, continuous slot in a side edge thereof for receiving opposed side edge portions of the book covers of the first and the differing width dimension therein, respectively.

4. The perfect binding system as in claim 1 wherein the first and at least one further pair of parallel guiderails are independently adjustable for establishing a desired spacing between members of the first pair and the further pair of parallel guiderails.

5. A method of operating a perfect binding system of a type including collating means for assembling plural signatures into books or magazines and delivering same to a perfect binding carousel for trimming and gluing together of signature spines, comprising the steps of:
(a) providing a cover conveyor for delivering covers, one at time, to a gluing station in synchronism with the arrival of the assembled and trimmed signatures;
(b) stacking a plurality of pairs of cover guiderails that are adjustably attached to the cover conveyor such that one member of each pair in the stack is arranged parallel to the other member of each pair and spaced laterally therefrom by a predetermined distance;
(c) providing a plurality of cover feeders for delivering covers of differing width dimension to the cover conveyor, one at a time, in non-overlapping condition with side edges of the covers delivered from each cover feeder being engaged by members of a different pair of the plurality of pairs of cover guiderails;
(d) advancing each cover along the cover conveyor in serial, non-over-lapping order to the gluing station; and
(e) adhesively bonding one of said covers to the signature spine of a predetermined book or magazine.

6. The method of claim 5 and further including an initial step of adjustably setting the spacing between members of each pair of the stacked pairs of guiderails to correspond with a width dimension of covers being delivered by a given one of the cover feeders.
